(19) United States
(12) Patent Application Publication
(10) Pub. No.: US 2006/0213824 A1
(43) Pub. Date: Sep. 28, 2006

(54) Column fitting device and method

(76) Inventors: Michael W. Higgins, Davenport, CA (US); David W. Ohanian, Sunnyvale, CA (US); Jeremy W. Higgins, Los Altos, CA (US)

Correspondence Address: PERKINS COIE LLP, P.O. BOX 2168, MENLO PARK, CA, 94026, US

(21) Appl. No.: 11/392,973

(22) Filed: Mar. 27, 2006

Related U.S. Application Data
(60) Provisional application No. 60/665,182, filed on Mar. 25, 2005.

(51) Int. Cl. B01D 15/08

(52) U.S. Cl. 210/198.2; 73/61.53; 73/61.52

(57) ABSTRACT

A fitting device for a tubular column having an exterior flange at one of its ends is disclosed. The device includes a fitting composed of (i) a piston for insertion into the end of the column adjacent the flange, (ii) an enlarged-diameter member having a contact surface for contacting the flanged end of the column when the piston is fully inserted into the column, and (iii) a circumferential seal encircling the piston for providing a fluid-tight seal between the piston and interior end region of the column, when the piston is inserted into the column. A clamp in the device is received on the column by sliding from the end of the column opposite said flange, for engaging the column flange and the fitting's enlarged-diameter member, to secure the fitting to the column flange, with the piston inserted into the tubular column, thus to maintain said seal when fluid is forced through the fitting by application of pressure to fluid within the column.

This application claims priority to U.S. provisional patent application No. 60/665,182 filed on Mar. 25, 2005, which is incorporated herein in its entirety by reference.

### FIELD OF THE INVENTION

The present invention relates to a column fitting device, such as a fitting device designed for use in flash chromatography, and to a packed chromatography column and to a sample loading column employing the fitting device.

### BACKGROUND OF THE INVENTION

Flash chromatograph is widely used for chromatographic separation of chemical or biochemical materials. In a typical flash-chromatography application, the column is prepared by equipping the downstream end of the column with a downstream fitting and frit, packing the column with a suitable separation matrix material, and sealing the top or upstream end of the column with a sealed fitting capable of supporting the internal pressures applied to the column during operation, e.g., 25-150 psi. Typically the column is formed of a polymeric material, e.g., polyethylene, which can withstand the expected internal pressures, and which is sufficiently transparent to allow the contents of the column to be viewed. The upstream fitting typically includes a sealed piston or plug which is inserted into the upper end of the column.

To date, various methods for attaching the upper fitting to the column have been proposed. One approach has been to glue the fitting plug to the interior wall of the column, using, for example, fast-setting cyanoacrylic glues capable of bonding to polymer surfaces. To date, however, there is no glue available that is capable of forming a strong and reliable bond to the smooth-polymer walls of the column. In addition to complicating the dismantling and replacement of the column, if that becomes necessary, this approach also introduces a potential source of chemical incompatibility and contamination.

Another approach has been to heat-weld the fitting plug to the column, once the plug is placed in the column, relying on the formation of a fused-polymer weld between the two. This approach requires special heating equipment and is unavailable where the packed column material is susceptible to heat damage.

A third approach employs a metal cage with a screw-on cap for immobilizing the column and the upstream fitting during column operation. In addition to the inconvenience and expense of the metal cage, the cage itself blocks easy viewing of the column and its contents.

There is thus a need for a column fitting that can be placed on a chromatography column, is capable of withstanding internal column pressures of between, typically, 50 psi to up to 150 psi or more, and which does not suffer from the prior-art disadvantages or limitations noted above.

### SUMMARY OF THE INVENTION

The invention includes, in one aspect, a fitting device for a tubular column having an exterior flange at one of its ends. The device includes a fitting composed of (i) a piston adapted to be inserted into the end of the column adjacent the column flange, (ii) an enlarged-diameter member having a contact surface adapted to contact the column flange when the piston is fully inserted into the column, and (iii) a circumferential seal encircling said piston, adapted to provide a fluid-tight seal between the piston and interior end region of the column, when the piston is inserted into the column. The piston provides a fluid passageway for communicating the interior of the column with an exterior port. A clamp in the device is received on the column by sliding from the end of the column opposite the column flange, and engages the column flange and the fitting's enlarged-diameter member, to secure the fitting to the column flange, with the piston inserted into the column, to maintain the seal when fluid is forced through the fitting by application of pressure to fluid within the column.

In one general embodiment, the fitting's enlarged diameter member includes an external threaded portion, and the clamp includes a threaded sleeve for engaging the threaded portion and a reduced-diameter lip for engaging the column flange when the sleeve is threaded on the fitting. The piston may be moved axially to a desired insertion position by tightening the threaded sleeve. Where the column is deformable in the region of the seal when pressure is applied to fluid in the column, the reduced-diameter lip of the clamp may encircle the column in the region of the seal, limiting the amount of column deformation that can occur in the region of the seal.

In another general embodiment, the piston is intended to be fully inserted into the column to a position at which the fitting's contact surface is in contact with the column flange. Here the clamp may include a snap-on, polymeric ring having an inner annular groove dimensioned to receive the column flange and enlarged-diameter member therein, when the ring is pressed over the column flange, and while engaging the enlarged-diameter structure. The clamps' inner annular groove is defined by a pair of annular ridges, one of which may be beveled to accommodate annular deformation of the ring as it is being forced over the fitting's enlarged-diameter member, and the other of which is dimensioned to engage the column flange. The exposed, fluid-contact surface of the piston may have a plurality of recessed channels formed therein for distributing fluid from the fitting over the cross-sectional area of the column. Alternatively, or in addition, this surface may be conically recessed for carrying fluid from the fitting into the column.

In another aspect, the invention includes a column assembly for use in flash chromatography and the like. The assembly includes a chromatographic column having an exterior flange at its upstream end and a tapered downstream end region, a chromatography medium filling the column, a fitting sealed in the column's downstream end and providing a fluid passageway for liquid flow out of the column, and a fitting device of the type described above sealing the upstream end of the column. In particular, the fitting device in the assembly may include a snap-on clamp for securing the fitting to the column.

The downstream end region of the column may be threaded, and the downstream fitting may have a threaded body threadedly attached to the column end region. The body may define an interior-facing well containing a frit therein for supporting the chromatography medium at the column's downstream end. Alternatively or in addition, the downstream fitting may have (i) a stem extending from the downstream end of the fitting body and adapted for friction-fit coupling to a coupling receptacle in a second flow device, and (ii) a cap rotatably mounted on the body adapted to rotatably engage a threaded portion of such receptacle, to lock the coupling stem within such receptacle.

In still another aspect, the invention includes a method of preparing a column of the type having a having an exterior flange at its upstream end and a downstream end region sealed with a downstream fitting, for use in flash chromatography. The method includes the steps of (a) adding a chromatography matrix material to the column to a level in the column within a given distance from the upstream end of the column, (b) positioning in the upstream end of the column, a fitting having (i) a piston insertable into the column end, (ii) a circumferential seal encircling said piston, for providing a fluid-tight seal between the piston and interior end region of the column, and (iii) an external threaded enlarged-diameter member opposite the piston, (c) engaging the threaded enlarged-diameter member with a threaded sleeve having a reduced-diameter lip for engaging the column flange when the sleeve is threaded on said fitting, and (d) tightening the sleeve on the fitting until the piston is brought into contact with the matrix material or into contact with a frit placed between the matrix material and the plug.

Also disclosed is a fitting/coupling device for a chromatography column or the like having a downstream threaded end region or socket. The device includes (i) a threaded body for threaded attachment to the column end region, where the body defines an interior-facing well, (ii) a frit contained within the well and designed for supporting the chromatography medium in the column, (iii) a coupling stem extending from the downstream end of the body for friction-fit coupling to a coupling receptacle in a flow device, and (iv) a cap rotatably mounted on the body for rotatably engaging a threaded portion of the coupling receptacle, to lock the coupling stem within such receptacle.

These and other objects and features of the invention will be more fully understood when the following detailed description is read in conjunction with the accompanying drawings.

### BRIEF DESCRIPTION OF THE DRAWINGS

FIGS. 1A and 1B are cross-sectional views showing the upper end portion of a chromatography column and steps in attaching a fitting device constructed according to one embodiment of the invention to the column end;

FIG. 2 additionally shows a lower end portion of the same column shown in FIG. 1, having a lower-end fitting/coupling device constructed according to another aspect of the invention; and

FIGS. 3A-3C are cross-sectional views showing the upper end portion of a chromatography column and steps in attaching a fitting device constructed according to a second embodiment of the invention to the column end; FIG. 3C additionally shows attachment of an upstream column to the upper end region of the first column employing a lower-end column fitting/coupling device like that shown in FIG. 2.

### DETAILED DESCRIPTION OF THE INVENTION

The present invention relates to fittings designed for sealing the ends of a pressurized column, for example, a column used for flash chromatography, and capable of withstanding operating pressures typically in the pressure range 25-150 psi or higher, e.g., up to about 200 psi. In one aspect of the invention, described in section A, the fitting is designed to cap an end of the column, and typically the upper end, which terminates in an end-flange. In a second aspect of the invention, described in Section B, a fitting/coupler is described that is designed to cap the lower, threaded out-flow end of a column.

A. Fitting for a Flanged Column End

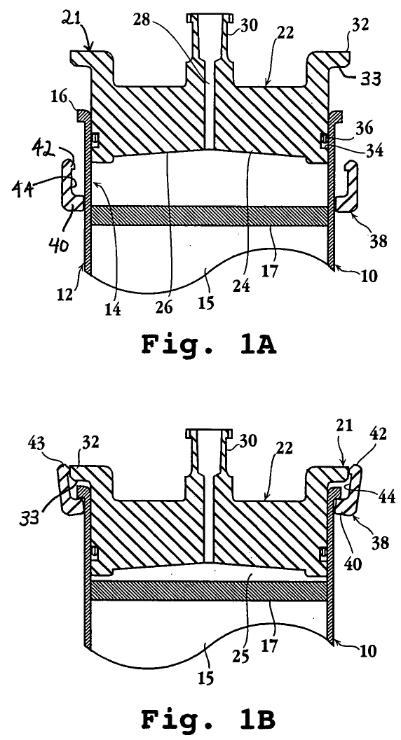

FIGS. 1A-1C illustrate in cross section, the upper end region 12 of a column 10 adapted to receive the fitting of the invention, for sealing the end of the column for fluid operating pressures in the fluid-pressure range of between about 25-200 psi, and typically a fluid-operating range suitable for flash chromatography, e.g., 25-150 psi. Column 10 includes a cylindrical wall portion 14 extending along most of the column length, and which terminates at its upper end in an annular flange 16. At its lower end, the column has a curved tapered end region 18 which terminates in a threaded socket 20. Column 10 may be a glass, plastic or metal column, typically a transparent plastic column, such as one formed of polyethylene, polypropylene, or the like. The column dimensions may vary widely, from small columns having inner diameters of a 5-10 mm, and column volumes of 50-150 ml, to large columns having inner diameters of up to 5-10 cm, and volumes of one to several liters. Such columns are widely available commercially, such as listed in the Thomas Register Directory, and accessed at the Register website:
http://www.thomasregisterdirectory.com/laboratory equipment supplies/chromat ography columns 0044633 1.html.

The column may be packed with a suitable chromatography or other packing material, such as silica gel, as indicated at 15 in the figures. The packing material, in turn, may be covered by a frit or filter 17 which separates the packing material from the upper end region of the column and acts to keep the upper surface of the chromatographic material relatively undisturbed during column operation, as fluid is being introduced into the column.

The upper end of the column is sealed with a fitting device 21 constructed according to a first embodiment of the invention. Device 21 includes a fitting 22 having a plug or piston 24 which is dimensioned to be snugly inserted into the column's flanged end, as shown. A channel 28 formed in the piston provides a fluid passageway for introducing fluid, e.g., liquid into the column through the fitting. Passageway 28 communicates at its upper end with a receptacle 30 designed for receiving the male stem of a fluid connector through which fluid may be supplied to the column. The lower surface of the piston in the figures has a shallow conical taper, as seen, to provide a fluid-flow space 25 between the piston and filter 17, thus to distribute fluid from the passageway evenly over the surface of the frit. Alternatively, or in addition, the lower piston surface can be formed with a plurality of grooves which radiate outwardly from the lower end of passageway 28 at angularly spaced intervals, for purposes of distributing fluid from the fitting evenly over the frit.

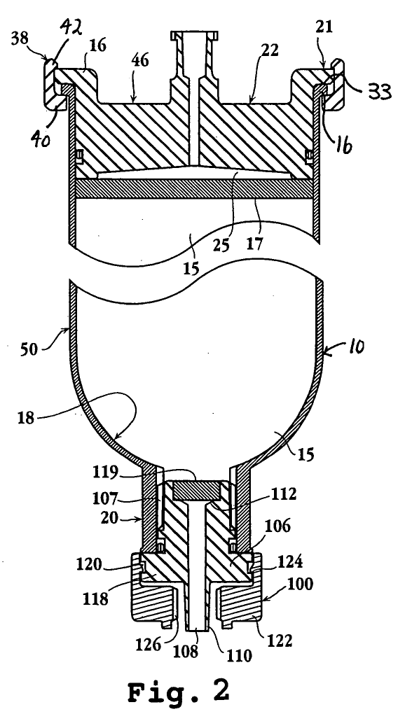

An O-ring seal 36 held in an annular groove 34 in the piston makes a fluid-tight seal between the piston and interior end region of the column when the piston is inserted into the column, as can be appreciated from the figures. The fitting also includes an annular flange or enlarged-diameter member 32 formed integrally with the piston and having a contact surface 33 which is pressed against the column flange in its operative, sealing position, as shown in FIG. 2. The fitting is preferably formed as an integral unit of a polymer (plastic) such as nylon, teflon, delrin, polyvinyl, polyethylene or the like, preferably formed by single-piece molding according to well-known methods.

For clamping the fitting to the column, the fitting device includes a snap-on ring or clamp 38 designed to lock the column and fitting flanges together, as shown in FIG. 2. As seen in the figures, the clamp has a pair of annular ridges or flanges 40, 42 (FIG. 1B) that define an inner groove 44 dimensioned to receive the column and fitting flanges, when the clamp is placed in its operative condition shown in FIG. 2. The upper surface of ridge 42 is beveled, as shown, to facilitate outward deformation of the ridge as it is moved over flange 32 in the fitting. Clamp 38 is preferably formed by single-piece molding of a rigid, slightly deformable plastic, such as the plastic used in forming fitting 22.

In operation, the lower end of the column is sealed with a downstream fitting, and the column is packed with a suitable material, such as silica gel to a level close to the top of the column, then covered with a frit, as shown. The position of the frit is preferably such that it is contacted by the lower surface of the fitting in its fully assembled condition, as seen in FIG. 2.

After filling the column, fitting 22 is inserted into the column, as shown in FIG. 1A, until the fitting flange's contact surface 33 is pressed against the column flange, as seen in FIG. 2. As noted above, the column packing height is preferably such that the fitting, when fully inserted in the column, contacts the upper surface of filter 17. Clamp 38, which is placed over the column's lower end, is now moved upwardly ion the column until it makes contact with the fitting flange. With continued upward movement of the ring, this contact acts to deform the upper rim of the clamp (FIG. 1B), allowing it to slip over the fitting flange until both column and fitting flanges are snugly received within the clamp's inner annular groove, as seen in FIG. 2. The clamp thus holds the fitting at the fully inserted position within the column, maintaining the O-ring seal between the fitting and column when fluid is introduced into the column under pressure through the fitting.

In another aspect, the invention includes a column assembly 50 for flash chromatography and the like which includes the fully assembled column shown in FIG. 2. The assembly includes a chromatographic column 10 having an exterior flange 16 at its upstream end and a tapered downstream end region 18 terminating at a threaded downstream receptacle 20 in which a downstream fitting/coupler device 100 (detailed in Section B below) is threadedly received. The column is filled with a chromatographic separation material 15, and capped at its upstream end, by fitting device 21 just described. This assembly is preferably preassembled for customer use, where the packing material is supplied either in dried or wet form, and the column is ready for use simply by introducing a suitable wash or conditioning medium through the column.

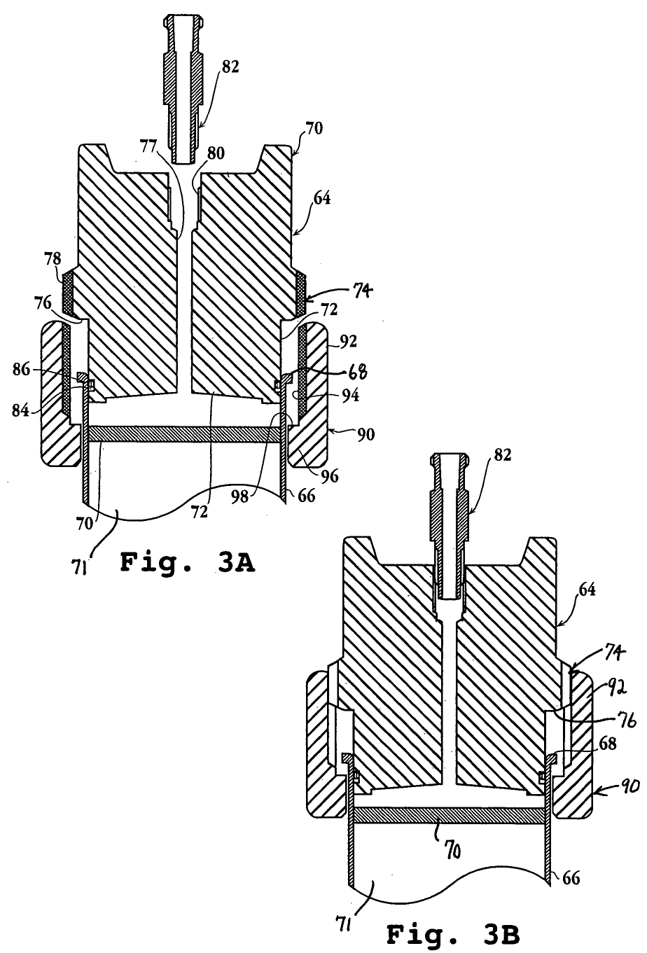

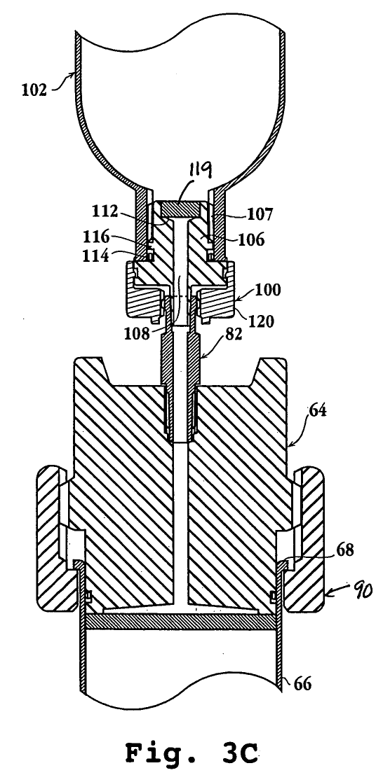

FIGS. 3A-3C illustrate a fitting device 64 constructed according to a second embodiment of the invention. Shown in the figures is the upper end portion of a flash chromatography column 66 having an upper-end flange 68, as described above for column 10. The column may be packed with a chromatography material 71 and covered by a frit or filter 70 also as described above. Unlike the fitting device described above, device 64 can be clamped in the column end at a variable plug depth, providing more flexibility in the height of the packing material, and also providing a means of applying pressure to the top of the packing material, for packing purposes.

Fitting device 64 includes a fitting 70 composed of a plug 72 dimensioned to be inserted snugly into the column bore, and an enlarged-diameter member 74 forming a contact surface or shelf 76 which, by contact with the column flange, limits the extent to which the plug can be inserted into the column bore. The enlarged-diameter member is threaded at 78 above contact surface 76 for a purpose to be described. A bore 77 formed through the fitting provides a passageway in the fitting between an upper fitting socket 80 and the lower end of the fitting in the figures. As seen in FIG. 3B and 3C, fitting socket 80 is designed to accept the male end of a connector 82.

The lower-end surface of plug 72 may be tapered, as shown, or grooved, to distribute liquid supplied through the fitting over the entire surface of filter 70, as described above for fitting device 10. Also as described above, an O-ring seal 84 carried in an annular groove 86 adjacent the lower end of the plug provides a seal for fitting within the column.

The fitting device includes a clamp 90 for clamping the fitting to the column. In the present embodiment, the clamp takes the form of a threaded sleeve 92 whose internal threads 94 engage threads 78 on the fitting's enlarged-diameter portion, for screwing the clamp on the fitting with rotation of the clamp. A lower annulus or flange 96 in the clamp provides a shelf 98 that engages the lower surface of the column flange, as shown in FIG. 3C, to lock the fitting to the clamp at a selected plug depth within the column. Flange 96 also provides column-wall support in the region of the fitting seal, serving to limit the extent of column deformation that can occur in the region of the seal as a result to fluid pressure within the column.

In operation, column 66 is equipped with a lower column fitting (similar to that shown in FIG. 2), then packed with a column material to a height close to the upper end of the column and capped with a filter 70. The fitting plug is now inserted into the column, as shown in FIG. 3A and clamp 96 is moved by sliding it from the lower end of the column up to a position, shown in FIG. 3B, where the clamp can be screwed onto the fitting body.

As can be appreciated from FIGS. 3B and 3C, as the clamp is tightened, and with the clamp flange engaging the column flange, the lower surface of the fitting plug is drawn into the column bore until it makes contact with the filter 70 in the column. Thus, the fitting device allows for the preparation of a packed column by (a) adding a chromatography matrix material to the column to a level in the column within a given distance from the upstream end of the column, and moving the plug of a column fitting by clamp tightening until the plug is brought into contact with the matrix material or into contact with a frit placed between the matrix material and the plug. The fitting device described is easily removed from a spent column, and reusable with a freshly packed column.

B. Fitting for a Threaded Column Socket

In another aspect, the invention includes a fitting/coupling device 100 seen in the lower part of FIG. 2, where the device serves as the downstream fitting for column 10 and in the upper part of FIG. 3C, where the device serves as the downstream fitting for a second column and attached to column 10 through connector 82.

With reference first to FIG. 2, device 100 is formed of a body 106 having a threaded region 107 whose threads engage the threaded receptacle forming the lower end of column 10. Body 106 has a central bore 108 which extends from an upstream cavity or well 112 formed in the body to a downstream stem 110 that is designed for engaging a fluid connector, such as connector 82 shown in FIG. 3C. The fitting is sealed in receptacle 20 by an O-ring seal 114 contained in an annular groove 116 formed in body portion 106. The lower portion of the body is radially enlarged at 118 and includes an annular groove 120 formed therein.

Well 112 formed at the upstream end of bore 108 is dimensioned to receive a filter or frit 119 therein. This frit serves as the lower filter support for packing material in the column, as seen in the figures, and obviates the needs for a separate filter normally used in to support column material in such a chromatography column. The filter thus adds the convenience for a packing operation, and also places the chromatography media directly against the lower frit, eliminating a gap between the filter and fitting at which mixing of separated sample components can occur.

Mounted on the lower portion of the body, for free rotation thereon, is a cap 122, which has an interior annular projection 124 confined within groove 120, allowing the cap to rotate freely on the lower end of body 106 while being held thereon. The cap has a threaded region 126 (FIG. 2) which engages a threaded projection on a fluid connector, such as connector 82 (FIG. 3C), to tighten the connector to the fitting device, by rotation of the cap. This feature allows a connector to be locked to or released from the fitting without having to disturb the position of the fitting in the column. This feature permits coupling a sample introduction column to a chromatography column. This feature also permits the coupling to two chromatography columns in order to obtain greater solute resolution and sample loading capacity. Additionally, it permits coupling different types of chromatography columns to enable mixed mode separations.

Fitting 100 is preferably formed of a rigid plastic, such as a polyvinyl, or polypropylene plastic, e.g., by injection molding. The cap is formed separately and pressed onto body 106.

From the foregoing, it can be appreciated how various objects and features of the invention are met. The fitting device of the invention is easy to attach to a column by mechanical attachment, is simple in construction, and provides a seal capable of withstanding pressure of up to 150 psi in flash chromatographic and related operations. In two of the embodiments described herein, the device is designed for snap-on assembly of a disposable, prepacked column. In another embodiment, the device is reusable and allows for user packing and column assembly by adjusting the position of the fitting plug to match the height of the column packing material.

The fitting coupler of the invention simplifies column assembly and packing by providing a lower frit that is carried on the fitting itself. The coupler/fitting is further designed for easy locking to and release from fluid couplers.

While the invention has been described with respect to particular embodiments and applications, it will be appreciated how various modifications and changes may be made without departing from the invention.

It is claimed:

1. A fitting device for a tubular column having an exterior flange at one of its ends only, comprising
(a) a fitting composed of (i) a piston adapted to be inserted into the end of the column adjacent said flange, and having a fluid passageway adapted to communicate the interior of the column with an exterior port, (ii) an enlarged-diameter member having a contact surface adapted to contact the flanged end of the column when the piston is fully inserted into the column, and (iii) a circumferential seal encircling said piston, adapted to provide a fluid-tight seal between the piston and interior end region of the column, when the piston is inserted into the column, and
(b) a clamp adapted to be received on said column by sliding from the end of the column opposite said flange, and to engage the column flange and the fitting's enlarged-diameter member, to secure the fitting to the column flange, with the piston inserted into the tubular column, thus to maintain said seal when fluid is forced through the fitting by application of pressure to fluid within the column.

2. The device of claim 1, wherein said fitting's enlarged-diameter member includes an external threaded portion and said clamp includes a threaded sleeve for engaging said threaded portion and a reduced-diameter lip for engaging the column flange when the sleeve is threaded on said fitting.

3. The device of claim 2, wherein said piston can be moved axially to a desired insertion position by tightening the threaded sleeve.

4. The device of claim 2, wherein said column is deformable in the region of said seal when pressure is applied to fluid in the column, and the reduced-diameter lip of said clamp encircles said column in the region of said seal, limiting the amount of column deformation that can occur in the region of the seal.

5. The device of claim 1, wherein said piston is intended to be fully inserted into the column to a position at which said contact surface is in contact with the column flange, and said clamp includes a snap-on, polymeric ring having an inner annular groove dimensioned to receive the column flange and fitting enlarged-diameter member therein, when the ring is pressed over the column flange, and while engaging said enlarged-diameter member.

6. The device of claim 5, wherein the clamps' inner annular groove is defined by a pair of annular ridges, one of which is beveled to accommodate annular deformation of the ring as it is being forced over the fitting's enlarged-diameter member, and the other of which is dimensioned to engage the column flange.

7. The device of claim 1, wherein said piston, when inserted in said column, has an exposed surface having a plurality of recessed channels formed therein for distributing fluid from the fitting passageway over the cross-sectional area of the column.

8. The device of claim 1, wherein said piston, when inserted in said column, has a surface that is conically recessed for distributing fluid from the fitting passageway over the cross-sectional area of the column.

9. A column assembly for flash chromatography and the like, comprising
a chromatographic column having an exterior flange at its upstream end and a tapered downstream end region,
a downstream fitting sealed in the column's downstream portion and providing a fluid passageway for liquid flow out of the column,
an upstream fitting composed of (i) a piston inserted into the end of the column adjacent said flange, and having a fluid passageway for liquid flow into the column, (ii) an enlarged-diameter member having a contact surface in contact with the column flange, and (iii) a circumferential seal encircling said piston and providing a fluid-tight seal between the piston and interior end region of the column, and capable of withstanding an internal column pressure of at least about 50 psi,
a snap-on polymeric ring having an inner annular groove in which the column flange and fitting's enlarged-diameter member are received, thus to maintain said seal when fluid is forced through the fitting by application of pressure to fluid within the column, and
a chromatography medium filing said column between said upstream and downstream fittings.

10. The column assembly of claim 9, wherein the downstream end region of the column is threaded, and the downstream fitting has a threaded body threadedly attached to the column end region, and said body defines an interior-facing well containing a frit therein for supporting the chromatography medium at the column's downstream end.

11. The assembly of claim 9, wherein the downstream end region of the column is threaded, and the downstream fitting has (i) a threaded body threadedly attached to the column end region, (ii) a coupling stem extending from the downstream end of said body and adapted for friction-fit coupling to a coupling receptacle in a second flow device, and (iii) a cap rotatably mounted on said body adapted to rotatably engage a threaded portion of such receptacle, to lock the coupling stem within such receptacle.

12. A method of preparing a column of the type having a having an exterior flange at its upstream end and a downstream end region sealed with a downstream fitting, for use in flash chromatography or the like, comprising
(a) adding a chromatography matrix material to the column to a level in the column within a selected distance from the upstream end of the column,
(b) positioning in the upstream end of the column, a fitting having (i) a piston insertable into the column end, (ii) a circumferential seal encircling said piston, for providing a fluid-tight seal between the piston and interior end region of the column, and (iii) an external threaded enlarged-diameter member opposite the piston,
(c) engaging the enlarged-diameter member of the clamp with a threaded sleeve having a reduced-diameter lip for engaging the column flange when the sleeve is threaded on said fitting, and
(d) tightening the sleeve on the fitting until the piston is brought into contact with the matrix material or into contact with a frit placed between the matrix material and the plug.

13. A fitting/coupling device for a chromatography column or the like having a threaded end region and designed to hold a chromatography medium, comprising
(i) a threaded body adapted to be threadedly attached to the column end region, said body defining an interior facing well,
(ii) a frit contained within said well and designed for supporting the chromatography medium in such column,
(iii) a coupling stem extending from the downstream end of said body and adapted for friction-fit coupling to a coupling receptacle in a flow device, and
(iv) a cap rotatably mounted on said body adapted to rotatably engage a threaded portion of such coupling receptacle to lock the coupling stem within such receptacle.
